(19) United States
(12) Patent Application Publication
(10) Pub. No.: US 2020/0132454 A1
(43) Pub. Date: Apr. 30, 2020

(54) UNDERGROUND INCLINOMETER SYSTEM

(71) Applicants: Keun Ho LEE, Gwangju-si, Gyeonggi-do (KR); Seung Heon LEE, Gwangju-si, Gyeonggi-do (KR); Song Heon LEE, Gwangju-si, Gyeonggi-do (KR)

(72) Inventors: Keun Ho LEE, Gwangju-si, Gyeonggi-do (KR); Seung Heon LEE, Gwangju-si, Gyeonggi-do (KR); Song Heon LEE, Gwangju-si, Gyeonggi-do (KR)

(21) Appl. No.: 16/493,204

(22) PCT Filed: Mar. 7, 2018
(86) PCT No.: PCT/KR2018/002707

§ 371 Date: Sep. 11, 2019

(30) Foreign Application Priority Data
Mar. 16, 2017 (KR) 10-2017-0032991

(51) Int. Cl. G01C 9/10; G01C 9/08; G01C 9/06

(52) U.S. Cl. CPC G01C 9/10; G01C 9/06; G01C 9/08

(57) ABSTRACT

The underground inclinometer system includes a probe having a displacement measurement sensor measuring displacement of the ground, a cable controller controlling the length of a cable inserted into the ground to move the probe within an inclinometer pipe, and a ground displacement calculator calculating the displacement of the ground by using displacement measurement information measured by the probe and information on the length of the cable controlled by the cable controller.

### CROSS-REFERENCE TO RELATED APPLICATIONS

This U.S. non-provisional patent application claims priority under 35 U.S.C. § 119 of Korean Patent Application No. 10-2017-0032991, filed on Mar. 16, 2017, the entire contents of which are hereby incorporated by reference.

### DESCRIPTION

### Technical Field

The present invention disclosed herein relates to an instrument for construction and civil engineering work, and more particularly, to an underground inclinometer inserted into the ground so as to measure displacement of the ground.

### Background Art

Underground inclinometers are used to determine the safety of ground relaxation areas and temporary structures by measuring the location, direction, size, and speed of each of a horizontal or vertical displacement of soil particles due to other influences such as cavitation at the time of excavation or filling and displacement of an underground water level, comparing the measured location, direction, size, and speed with estimated design displacements, and examining the comparison results.

Underground inclinometers are mainly used to measure displacement in excavation work such as subway construction or sheathing work, measure deformation of piers and abutments, measure estimated slip surfaces of slopes, and measure displacement of tunnels, vertical mines, dams, and other various embankments.

FIG. 1 is a view illustrating a service state of a conventional underground inclinometer. A normal underground slope measurement method inserts an inclinometer probe 11 into an underground hole and measures a slope for each depth while pulling up a measurement cable 14, as illustrated in FIG. 1.

The probe 11 has a displacement sensor 12 and spring wheels 13, and the cable 14 has a connection part 15 for connection with the probe 11. The probe 11 is moved by using the cable 14, and the cable 14 is adjusted in length by being wound or unwound from a drum 16 by the force of a person or a machine such that the location of the probe 11 is changed.

Wirings, through which power and data can move, are provided inside the cable 14 to supply the power from the outside to the probe 11 and transmit measured data to an external output device 17.

For use of the underground inclinometer, the cable 14 is supported by a cable support device 18 to be repeatedly wound or unwound from the drum 16.

Such a repeated operation causes the cable 14 to be damaged. Since the cable 14 of the related art has the wirings thereinside, the cable 14 can be damaged more easily. The cost of the cable is expensive, and thus, the replacement cost increases. More energy is consumed for movement of the probe 11 because the wirings increase the weight of the cable 14.

Further, the cable cannot be easily replaced once damaged, so that the time or cost significantly increase, and it is difficult to accurately adjust the location of the probe 11 because the position of the probe 11 is adjusted according to the length of the cable.

### DISCLOSURE OF THE INVENTION

### Technical Problem

The present invention provides an underground inclinometer system, which is light and inexpensive and hardly damages a cable.

The present invention also provides an underground inclinometer system capable of measuring an accurate probe location regardless of deformation of the cable.

### Technical Solution

In accordance with an exemplar embodiment, an underground inclinometer system includes: a probe having a displacement measurement sensor configured to measure displacement of the ground; a cable controller configured to control the length of a cable inserted into the ground to move the probe within an inclinometer pipe; and a ground displacement calculator configured to calculate the displacement of the ground by using displacement measurement information measured by the probe and information on the length of the cable controlled by the cable controller.

The probe includes a sensor power supply unit, a displacement storage unit, and a ground displacement measurement time information acquisition unit. The sensor power supply unit supplies power to the displacement measurement sensor. The displacement storage unit stores a displacement measurement value measured by the displacement measurement sensor. The ground displacement measurement time information acquisition unit acquires ground displacement measurement time information of the displacement measurement sensor.

The ground displacement calculator includes a cable length measurement unit and a cable length measurement time information acquisition unit. The cable length measurement unit measures the length of the cable controlled by the cable controller. The cable length measurement time information acquisition unit acquires cable length measurement time information of the cable length measurement unit.

By such a configuration, the cable of an underground inclinometer may be made lighter, cheaper, and more difficult to break because internal wirings may be removed from the cable adjusting the location of the probe. The displacement of the ground may be accurately measured even when the cable is deformed or replaced.

The ground displacement calculator may further include: a probe power supply unit configured to supply the power to the sensor power supply unit when the probe approaches within a preset distance; and a storage information reception unit configured to receive storage information of the displacement storage unit when the probe approaches within the preset distance. By such a configuration, the supply of the power to the probe or the acquisition of the information from the probe may be easily performed by carrying out communications and power charging by wire or wireless when the probe rises to the around surface.

The underground inclinometer system may further include a probe acceleration measurer configured to measure the acceleration of the probe. By such a configuration, abnormal data may be prevented from being measured by the probe being vibrated.

The underground inclinometer system may further include a displacement calculator acceleration measurer configured to measure the acceleration of the displacement calculator. By such a configuration, the abnormal data may be prevented from being measured by the probe due to vibrations on the ground.

The cable controller may stop change of the length of the cable when the acceleration of the displacement calculator is above a preset criterion. By such a configuration, when vibrations occur on the ground, the probe may measure changes in the ground after the vibrations by stopping movement of the probe.

The probe may further include: rotating bodies each moving while rotating in contact with an inner surface of the inclinometer pipe; and a rotational amount measurement unit configured to measure a rotational amount of the rotating body. By such a configuration, the changes in the ground may be measured when the movement of the probe through the inclinometer pipe stops even when vibrations occur in the probe by identifying the movement of the probe through the inclinometer pipe from a rotational amount of the rotating body.

The rotational amount measurement unit may include: magnetic field generation parts formed in partial areas of the rotating body so as to generate a magnetic field while rotating according to the rotating of the rotating body; and a rotational speed calculation part configured to measure the magnetic field so as to calculate a rotational speed of the rotating body. The rotational amount measurement unit may also measure displacement of a rotating angle of the rotating body so as to measure the rotational amount of the rotating body.

The probe further may further include: a probe location calculation unit configured to calculate the location of the probe by using information on the rotational amount of the rotating body. By such a configuration, the location of the probe may be identified by using the rotational amount of the rotating body provided in the probe, independently of the information on the length of the cable.

The magnetic field generation parts may be respectively formed in a plurality of areas asymmetrical in a rotational direction of the rotating body with respect to a rotating axis of the rotating body. In particular, the magnetic field generation parts may be respectively formed in two areas having distances varying therebetween in the rotational direction of the rotating body with respect to the rotating axis of the rotating body. By such a configuration, the location of the probe may be identified more accurately by identifying the rotational direction of the rotating body even with a simple structure.

The probe location calculation unit may calculate the location of the probe from the rotational speeds of the rotating bodies calculated for the rotating bodies different from each other. By such a configuration, various unexpected error factors which may occur in one rotating body may be easily corrected.

### Advantageous Effects

In accordance with an exemplary embodiment, a cable of an underground inclinometer may be made lighter, cheaper, and more difficult to break because internal wirings may be removed from the cable adjusting the location of a probe. Further, displacement of the ground may be accurately measured even when the cable is deformed or replaced.

Further, supply of power to a probe acquisition of information from the probe may be easily performed by carrying out communications and power charging by wire or wireless when the probe rises to the ground surface.

Further, abnormal data which may be measured by the probe being vibrated may be prevented.

Further, when vibrations occur on the ground, the abnormal data which may be measured by the probe may be prevented.

Further, when vibrations occur on the ground, the probe may measure changes in the ground after the vibrations by stopping movement of the probe.

Further, the changes in the ground may be measured when the movement of the probe through an inclinometer pipe stops even when vibrations occur in the probe by identifying the movement of the probe through the inclinometer pipe from a rotational amount of a rotating body.

Further, the location of the probe may be identified by using the rotational amount of the rotating body independently of information on the length of the cable.

Further, the location of the probe may be accurately identified by identifying a rotational direction of the rotating body even with a simple structure.

Further, various unexpected error factors which may occur in one rotating body may be easily corrected.

### BRIEF DESCRIPTION OF THE DRAWINGS

FIG. 1 is a view illustrating a service state of a conventional underground inclinometer;

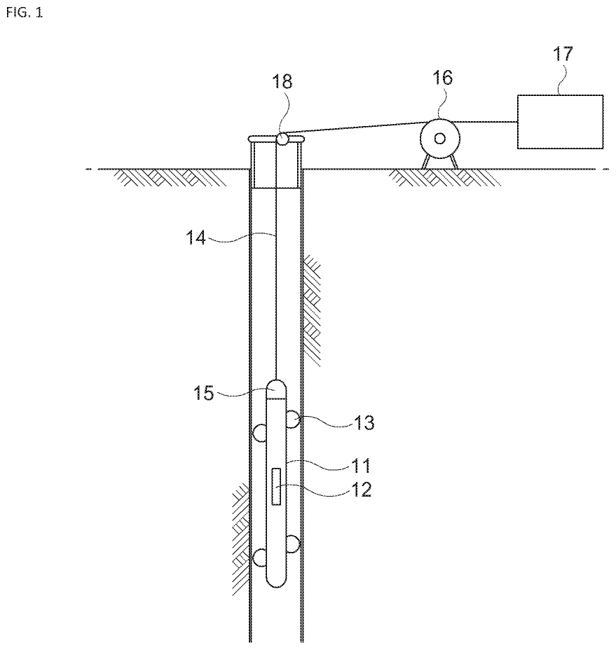

FIG. 2 is a schematic block diagram of an underground inclinometer system in accordance with an exemplary embodiment;

FIG. 3 is a schematic view of use of the underground inclinometer system of FIG. 2;

FIG. 4 is a schematic view of a rotating body and magnetic field generation parts formed inside the rotating body of FIG. 2; and

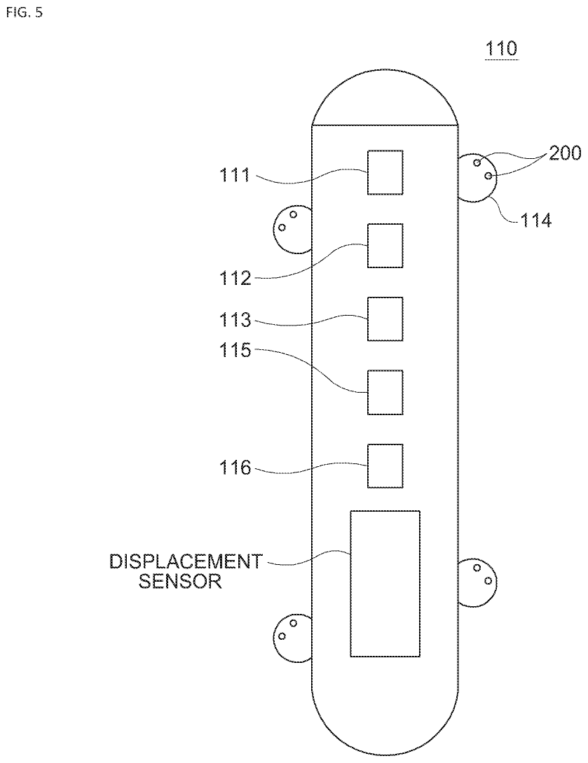

FIGS. 5 and 6 are schematic views of examples of a probe of FIG. 2.

### MODE FOR CARRYING OUT THE INVENTION

Preferred embodiments of the present invention will be described hereinafter with reference to the accompanying drawings.

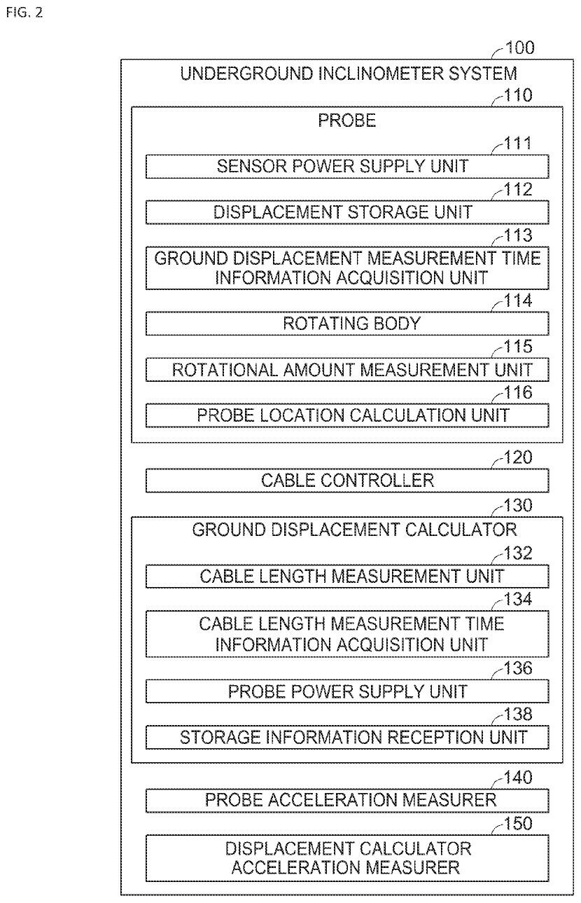

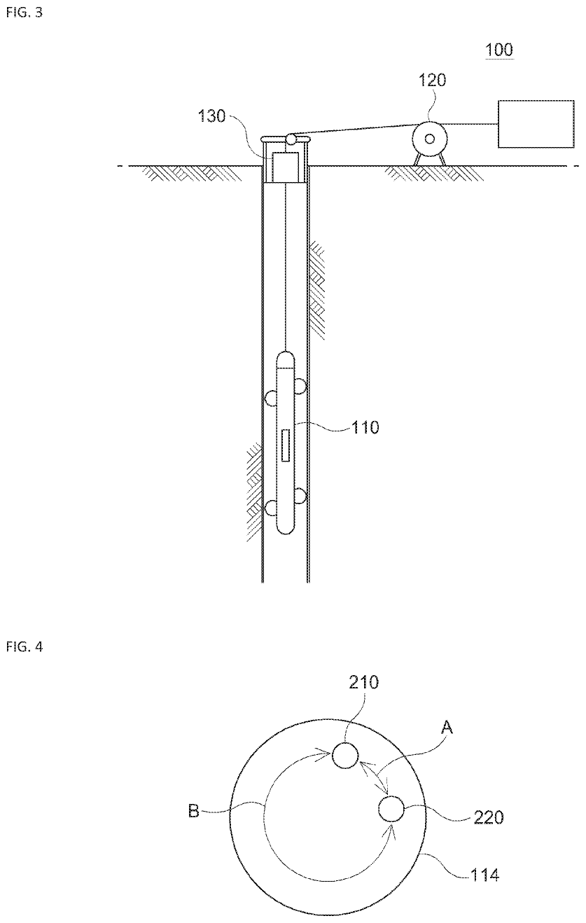

FIG. 2 is a schematic block diagram of an underground inclinometer system in accordance with an exemplary embodiment, and FIG. 3 is a schematic view of use of the underground inclinometer system of FIG. 2.

In FIG. 2, an underground inclinometer system 100 includes: a probe 110 having a displacement measurement sensor measuring displacement of the ground; a cable controller 120 controlling the length of a cable inserted into the ground to move the probe 110 within an inclinometer pipe; a ground displacement calculator 130 calculating the displacement of the ground by using displacement measurement information measured by the probe 110 and information on the length of the cable controlled by the cable controller; a probe acceleration measurer 140; and a displacement calculator acceleration measurer 150.

The probe 110 includes a sensor power supply unit 111, a displacement storage unit 112, a ground displacement measurement time information acquisition unit 113, rotating bodies 114, a rotational amount measurement unit 115, and a probe location calculation unit 116, and the ground displacement calculator 130 includes a cable length measurement unit 132, a cable length measurement time information acquisition unit 134, a probe power supply unit 136, and a storage information reception unit 138.

The sensor power supply unit 111 supplies power to the displacement measurement sensor measuring the displacement of the ground. The displacement storage unit 112 stores a displacement measurement value measured by the displacement measurement sensor. The ground displacement measurement time information acquisition unit 113 acquires ground displacement measurement time information of the displacement measurement sensor.

The cable length measurement unit 132 measures the length of the cable controlled by the cable controller 120, and the cable length measurement time information acquisition unit 134 acquires cable length measurement time information of the cable length measurement unit 132.

In this case, the cable length measurement unit 132 may be provided as a rotating encoder capable of identifying a length by which the cable (wire) is wound or unwound, and even when the cable is deformed, the cable length measurement unit 132 may perform the measurement while maintaining a predetermined interval.

The ground displacement calculator 130 calculates the displacement of the ground by using the displacement measurement information measured by the probe 110 and the information on the length of the cable controlled by the cable controller 120. In this case, the ground displacement calculator 130 synchronizes time measured by the ground displacement measurement time information acquisition unit 113 and the cable length measurement time information acquisition unit 134.

By such a configuration, the cable of an underground inclinometer may be made lighter, cheaper, and more difficult to break because internal wirings may be removed from the cable adjusting the location of the probe 110. Further, the displacement of the ground may be accurately measured even when the cable is deformed or replaced.

The probe power supply unit 136 supplies the power to the sensor power supply unit 111 when the probe approaches within a preset distance, and the storage information reception unit 138 receives storage information of the displacement storage unit 112 when the probe 110 approaches within the preset distance.

The power supply or information transmission may be implemented so as to be performed while the probe 110 and the ground displacement calculator 130 are in physical contact with each other, but may also be implemented so as to be performed while the probe 110 and the ground displacement calculator 130 are spaced apart from each other by a short distance. When the power supply and information transmission are performed while the probe 110 and the ground displacement calculator 130 are spaced apart from each other, the probe power supply unit 136 and the storage information reception unit 138 may be provided so as to be spaced apart from each other by a predetermined interval to prevent a mutual interference therebetween.

By such a configuration, the supply of the power to the probe 110 or the acquisition of the information measured from the probe 110 may be easily performed by carrying out communications and power charging by wire or wireless when the probe 110 rises to the ground surface.

The probe acceleration measurer 140 measures the acceleration of the probe 110. The probe acceleration measurer 140 may be provided as an acceleration sensor provided in the probe 110 and may also be provided to store the measured displacement of the ground only when the measured acceleration is below a preset criterion. By such a configuration, abnormal data may be prevented from being measured by the probe 110 being vibrated.

The displacement calculator acceleration measurer 150 measures the acceleration of the displacement calculator 130. The displacement calculator acceleration measurer 150 may be provided as an acceleration sensor provided in a cable driving device (drum) and measures ground vibrations in the displacement calculator 130 that may occur due to surrounding traffic conditions or the like.

By such a configuration, when vibrations occur on the ground, the abnormal data which may be measured by the probe may be prevented. In particular, when the probe 110 is near the ground surface, the effect is even greater.

The cable controller 120 stops change of the length of the cable when the acceleration of the displacement calculator 130 is above a preset criterion. By such a configuration, when vibrations occur on the ground, the cable controller 120 may stop movement of the probe 110 through the cable length control such that the probe 110 may measure changes in the ground after the vibrations.

The rotating bodies each move while rotating in contact with an inner surface of the inclinometer pipe. In this case, the rotating body 114 may be provided as a spring wheel or the like provided in the probe 110. Magnetic field generation parts 200 are formed in partial areas of the rotating body 114 so as to generate a magnetic field while rotating according to the rotating of the rotating body 114. In this case, the magnetic field generation parts 200 may be respectively formed in a plurality of areas asymmetrical in a rotational direction of the rotating body 114 with respect to a rotating axis of the rotating body 114.

In particular, the magnetic field generation parts 200 may be respectively formed in two areas having distances varying therebetween in the rotational direction of the rotating body 114 with respect to the rotating axis of the rotating body 114. By such a configuration, the location of the probe 110 may be identified more accurately by identifying the rotational direction of the rotating body even with a simple structure.

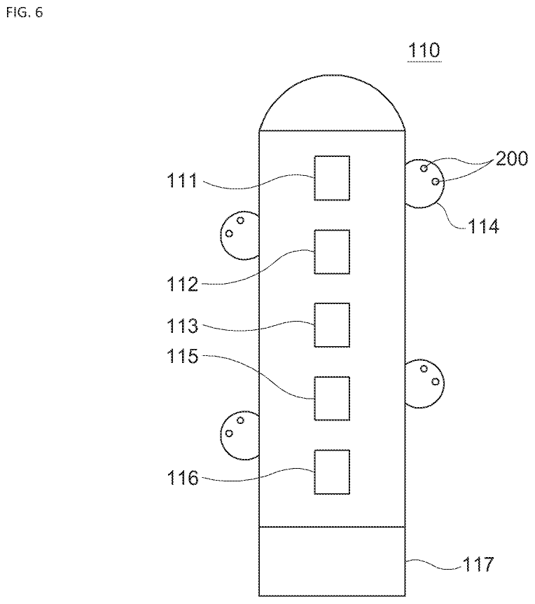

FIG. 5 is a schematic view of a rotating body and magnetic field generation parts formed inside the rotating body of FIG. 2. In FIG. 5, two magnetic field generation areas 210 and 220 are formed inside the rotating body 114. By such a configuration, rotation of a wheel may be recognized even with a simple structure because it is not required to provide the rotating bodies 114 with an additional power supply or communication device.

In particular, it can be seen that the two magnetic field generation areas 210 and 220 are formed to have distances varying therebetween in the rotational direction. That is, it can be seen that distance A and distance B are not equal. By such a configuration, the rotational direction of the rotating body 114 may be identified by using only a difference in detection time between magnetic fields generated from the two magnetic field generation areas 210 and 220.

The rotational amount measurement unit 115 measures the generated magnetic fields so as to calculate a rotational speed of the rotating body 114. The rotational amount measurement unit 115 may identify the rotating of the rotating body 114 on the basis of changes in the intensity of the magnetic field that periodically change according to the rotating of the rotating body 114 and may determine the number of times of repetition of a change period as the rotational speed of the rotating body 114.

The rotational amount of the rotating body 114 may be indirectly measured as described above and may also be directly measured by using an encoder provided inside or outside thereof In this case, the rotational amount of the rotating body may be measured by measuring displacement of a rotating angle of the rotating body 114.

The probe location calculation unit 116 calculates the location of the probe 110 by using the calculated rotational amount of the rotating body 114. In this case, the probe location calculation unit 116 may calculate the location of the probe 110 from the rotational speeds of the rotating bodies calculated for the rotating bodies 114 different from each other. By such a configuration, various unexpected error factors which may occur in one rotating body 114 may be easily corrected.

The current location of the probe 110 may be calculated by using the rotational speed of the rotating body 114 on the basis of a preset point. When the rotational speeds are respectively measured for the rotating bodies 114, an unexpected error situation such as a slip may be recognized and the current location may be accurately measured by using rotational speeds measured from the other rotating bodies even when the unexpected error situation occurs in some of the rotating bodies.

All components of the probe 110 may be provided such that the components are included inside the probe 110 to be integrally formed, and may also be provided such that the components are formed to have a conventional probe structure including a displacement sensor and a structure connected between the conventional probe structure and the cable and including the other components of the probe 110 except the displacement sensor so as to be connected to each other by a probe connection part 117.

FIGS. 5 and 6 are schematic views of examples of a probe of FIG. 2. FIG. 5 illustrate an example in which the probe 110 includes a displacement sensor d is integrated therewith, and FIG. 6 illustrates an example in which a structure including the remaining components of the probe 110 is coupled to the conventional structure of the probe 110 including a displacement sensor.

It can be seen that FIG. 5 does not illustrate the probe connection part 117 illustrated in FIG. 6, and the magnetic field generation parts 200 are formed in the spring wheels 114 of the probe 110 itself.

Although the present invention has been described by some preferred embodiments, the scope of the present invention is not limited thereto, and covers modifications or improvements in the embodiments supported by the claims.

1. An underground inclinometer system comprising:
a probe comprising a displacement measurement sensor configured to measure displacement of the ground;
a cable controller configured to control the length of a cable inserted into the ground to move the probe within an inclinometer pipe; and
a ground displacement calculator configured to calculate the displacement of the ground by using displacement measurement information measured by the probe and information on the length of the cable controlled by the cable controller,
wherein the probe comprises:
a sensor power supply unit configured to supply power to the displacement measurement sensor;
a displacement storage unit configured to store a displacement measurement value measured by the displacement measurement sensor; and
a ground displacement measurement time information acquisition unit configured to acquire ground displacement measurement time information of the displacement measurement sensor, and
the ground displacement calculator comprises:
a cable length measurement unit configured to measure the length of the cable controlled by the cable controller; and
a cable length measurement time information acquisition unit configured to acquire cable length measurement time information of the cable length measurement unit.

2. The underground inclinometer system of claim 1, wherein the ground displacement calculator further comprises:
a probe power supply unit configured to supply the power to the sensor power supply unit when the probe approaches within a preset distance; and
a storage information reception unit configured to receive storage information of the displacement storage unit when the probe approaches within the preset distance.

3. The underground inclinometer system of claim 2, further comprising a probe acceleration measurer configured to measure the acceleration of the probe.

4. The underground inclinometer system of claim 3, further comprising a displacement calculator acceleration measurer configured to measure the acceleration of the displacement calculator.

5. The underground inclinometer system of claim 4, wherein the cable controller stops change of the length of the cable when the acceleration of the displacement calculator is above a preset criterion.

6. The underground inclinometer system of claim 5, wherein the probe further comprises:
rotating bodies each moving while rotating in contact with an inner surface of the inclinometer pipe; and
a rotational amount measurement unit configured to measure a rotational amount of the rotating body.

7. The underground inclinometer system of claim 6, wherein the probe further comprises: a probe location calculation unit configured to calculate the location of the probe by using information on the rotational amount of the rotating body.

8. The underground inclinometer system of claim 7, wherein the rotational amount measurement unit comprises:
magnetic field generation parts formed in partial areas of the rotating body so as to generate a magnetic field while rotating according to the rotating of the rotating body; and
a rotational speed calculation part configured to measure the magnetic field so as to calculate a rotational speed of the rotating body.

9. The underground inclinometer system of claim 8, wherein the magnetic field generation parts are respectively formed in a plurality of areas asymmetrical in a rotational direction of the rotating body with respect to a rotating axis of the rotating body.

10. The underground inclinometer system of claim 9, wherein the magnetic field generation parts are respectively formed in two areas having distances varying therebetween in the rotational direction of the rotating body with respect to the rotating axis of the rotating body.

11. The underground inclinometer system of claim 10, wherein the probe location calculation unit calculates the location of the probe from the rotational speeds of the rotating bodies calculated for the rotating bodies different from each other.

12. The underground inclinometer system of claim 11, wherein the rotational amount measurement unit measures displacement of a rotating angle of the rotating body so as to measure the rotational amount of the rotating body.
